(19) United States
(12) Patent Application Publication
(10) Pub. No.: US 2012/0084203 A1
(43) Pub. Date: Apr. 5, 2012

(54) SYSTEM AND METHOD FOR SECURE TRANSACTIONS USING DEVICE-RELATED FINGERPRINTS

(75) Inventors: Evans Mehew, Larkspur, CO (US); Kimberly Dunwoody, Parker, CO (US); Gail Galuppo, Lone Tree, CO (US)

(73) Assignee: The Western Union Company, Englewood, CO (US)

(21) Appl. No.: 12/894,456

(22) Filed: Sep. 30, 2010

(51) Int. Cl. G06Q 40/00

(52) U.S. Cl. 705/41; 705/44

(57) ABSTRACT

A system for conducting money transfer transactions includes a wallet application at a mobile network host that facilitates the collection of fingerprint data at a mobile user device and that maintains wallets where the fingerprint data corresponding to a user device is stored as a reference fingerprint. The fingerprint data includes both device feature characteristics and device use characteristics. When a transaction is conducted a the user device, current fingerprint data from the user device is compared to the reference fingerprint, and the transaction is permitted based on the comparison.

### CROSS-REFERENCES TO RELATED APPLICATIONS

The present application is related to U.S. patent application Ser. No. ______ (Attorney Docket Number 026595-018200US) entitled “SYSTEM AND METHOD FOR SECURE TRANSACTIONS AT A MOBILE DEVICE” which is filed on even date herewith and incorporated herein by reference for all purposes.

### BACKGROUND OF THE INVENTION

This invention relates generally to financial transfers. More specifically, the invention relates to financial transfers where the transfer is conducted at a user device, and where a device fingerprint is used for authenticating the device.

Third party money transfer services are widely used to transfer money and pay bills through the use of wire transfers, money orders, and the like. Such services, however, usually require face-to-face contact between an individual representing the third party service provider and the sender and/or the receiver. For example, if a sender is “wiring” money to a receiver, the money is typically deposited with the third party in person, and the sender typically obtains the money from the third party in person. If the money is transferred in the form of a money order, the sender typically deposits the money with the third party in person and receives a money order.

The use of mobile devices in various types of transactions is becoming more common. For example, various forms of wireless or mobile devices, such as cell phones or Personal Digital Assistants (PDAs), can be used to initiate a contactless communication with a Point-Of-Sale (POS) device or other terminal, in order for the user of the device to pay for goods and services or to transfer funds to another party. These devices provide greater convenience to the user, and can also be used to provide other functions with regard to financial accounts to which they may be linked or related. However, money transfer services and systems are sometimes vulnerable to fraud, e.g., a dishonest person may attempt to send or receive money by impersonating a legitimate transferor or transferee. While systems employing a mobile device will frequently require a user to know a unique username, a password or some other security code in order to make a transaction more secure, such arraignments can be circumvented. For example, an unauthorized person might surreptitiously learn a security code, e.g., by watching a user enter his or her code at a device, by employing systems that hack money transfer systems and gain access to codes, or by learning enough about a user to make attempts to guess a code until one guessed code is found to work. Hence, there is a need in the art for improving the security of financial transactions conducted at a user device, such as a mobile device.

### BRIEF SUMMARY OF THE INVENTION

There is provided, in accordance with embodiments of the present invention, a network/system and method for providing secure financial transactions, such as money transfer transactions conducted by a user at a mobile device.

In one embodiment, a system and method provides security to a financial transaction conducted at a user device. The user device collects fingerprint data. The fingerprint data includes both data relating to features of the user device (e.g., identifying aspects of device components, such as characteristics relating to an operating system, applications, and a browser installed at the user device) and data relating to use of the user device (e.g., identifying aspects of device use, such as characteristics relating to emails, telephone calls, websites visited by the user device and a location of the user device). Initially collected fingerprint data is provided to a host computer, and stored as a reference fingerprint. When a transaction is conducted, current fingerprint data is collected at the user device and transmitted to the host computer. The current fingerprint data and the reference fingerprint are compared at the host computer, and based on the comparison, the host computer determines whether to authorize the financial transaction.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram of a money transfer system, illustrating one embodiment of the invention.

FIG. 2 is a block diagram of a computer system upon which various devices/systems illustrated in FIG. 1 may be implemented.

FIG. 3 is a flow diagram of a process for capturing fingerprint data in the system of FIG. 1.

FIG. 4 is a flow diagram of a process for authenticating device fingerprints as part of a transaction request in the system of FIG. 1.

FIG. 5 illustrates a fingerprint file populated with fingerprint data, in a mobile device of the system of FIG. 1.

### DETAILED DESCRIPTION OF THE INVENTION

In the following description, numerous specific details are set forth in order to provide an understanding of various embodiments of the present invention. It will be apparent, however, to one skilled in the art that embodiments of the present invention may be practiced without some of these specific details. In other instances, well-known structures and devices are shown in either block diagram form or omitted to avoid obscuring more salient features of the invention.

Generally speaking, embodiments of the present invention provide methods and systems for supporting financial transfer transactions initiated by and/or conducted through a variety of channels, including but not limited to a wireless communication channel employing a wireless communication device. Exemplary systems and methods for performing money transfer transactions via a wireless communication device, such as such as a cellular phone or personal communication device (e.g., iPhone®, Blackberry®, PalmPilot® or similar device) are described in co-pending U.S. patent application Ser. No. 11/462,223 filed Aug. 3, 2006 by Blair et al. and entitled MONEY TRANSFER TRANSACTIONS VIA PRE-PAID WIRELESS COMMUNICATION DEVICES, and co-pending U.S. patent application Ser. No. 12/4477,360, filed Jun. 3, 2009, by Dill et al. and entitled MONEY TRANSFERS UTILIZING A UNIQUE RECEIVER IDENTIFIER, the complete disclosures of which are herein incorporated by reference in their entirety for all purposes.

In exemplary embodiments of the invention, a money transfer method and system is provided for consumer-oriented money transfers between users (e.g., a money sender and a money receiver), one or more of whom may use a mobile or wireless device to conduct transfers. The transfers may be between accounts maintained at a mobile wallet application, maintained at a financial institution, maintained by a money transfer facilitator, or some combination of the foregoing. Enhanced security is provided by authenticating the transactions using device fingerprints established for user devices. Each fingerprint is based on both device feature characteristics (e.g., aspects of device hardware or software) and device use/behavior characteristics (e.g. aspects of how the device has been used by the user). It is assumed that, for most devices and their users, at least some of the characteristics will vary or change over time, as the device is operated by the user and as software (applets, plug-ins, add-ons, extensions and other software components) are added or changed by the user. Such changes are readily accommodated in the exemplary embodiments.

In one described embodiment, device feature characteristics include data pertaining to the device operating system, browser software, and other software (e.g., applications or plug-ins). As an example, device feature characteristics may include operating system characteristics (e.g., operating system name/ID, version, and install date), browser characteristics (e.g., browser name/ID, version, and install date), and other characteristics relating to applications, applets or plug-ins that have been installed (e.g., plug-in name/ID, version, and install date). Device use characteristics include data resulting from the operation of the device by the user. An example of device use characteristics is data based on logs of recent emails (e.g., aspects or patterns for such emails), logs of recent phone calls made from or received at the device (e.g., aspects or patterns for such calls), and logs of recent websites visited using the browser(s) on the device.

In one embodiment, authentication is controlled at a mobile wallet application running at a host computer system of a network operator. The wallet application downloads a program to the mobile device for collecting fingerprint data. The downloading can occur at an agent location (which may provide increased security) or can take place using a communications channel over a mobile network. The fingerprint data is stored at the mobile device and also communicated to a digital or mobile wallet (implemented at the wallet application at the host) for later use in authenticating and authorizing transactions.

Each user conducting transfers may have his or her own wallet (as implemented at the mobile wallet application), but in an alternative embodiment multiple users may each use a single wallet, with that single wallet authenticating both the device used by the money sender and the device used by the money receiver. In some cases, there may be more than two users recognized at a wallet so that, for example, one user (as a sender) may transfer money to several other users (as receivers). In addition, the role of each user (either as a sender or as a receiver) may be reversed depending on the circumstances (i.e., at one point in time, a user may want to send money and at another point in time a user may want to receive money). As will be understood from embodiments to be described later, having multiple users at a single wallet that authenticates each of those users increases the security of a transaction (i.e., a transaction is authenticated only if each of the multiple users involved in the transaction are authenticated, so that a detected fraudster impersonating any one of the users will cause the entire transaction to be rejected).

While described embodiments relate to consumer-oriented money transfer transactions—money be sent from one user (as a sender) to another user (as a receiver)—other types of transactions may also benefit from the features of the present invention. For example, the invention may be employed where the transaction is a retail transaction, e.g., a user of a mobile device is purchasing a product, and the transaction is crediting money or other value to the account of a merchant. As another example, the invention could be employed where a mobile device user wants to perform a transaction not involving the transfer of money or other value, but rather taking an action that could be compromised if an unauthorized person has improperly obtained access to the user device. One such a transaction not involving a money transfer might be the renewal of a passport using a mobile device, where an agent renewing the passport is able to authenticate the user (and his or her device) as the proper passport holder using device fingerprint data, so that the renewed passport is not issued to an imposter.

In some embodiments, a system employing the present invention is not dedicated to a single type of transaction (e.g., a money transfer), but rather transactions of different types (e.g., some involving money transfers and other involving non-monetary transactions), with the system being able to authenticate the user and his/her device in each instance (involving different types of transactions) using fingerprint data.

It should also be appreciated that the features of the present invention could be used in connection with non-mobile devices. In its broadest sense, the present invention could be used in communications between any two devices or systems through any communications network, whether using a fixed network (wire line, fiber optic, etc.) or a wireless network (e.g., cellular, radio-based, optical, or infrared based, etc.). As mentioned earlier, the present invention may have particular advantage where one of the users has a mobile device (since such devices may be more easily stolen and used for improper purposes), but such advantages may also be present in the case of user devices that are not mobile and normally used at a fixed location (e.g., a desktop computer).

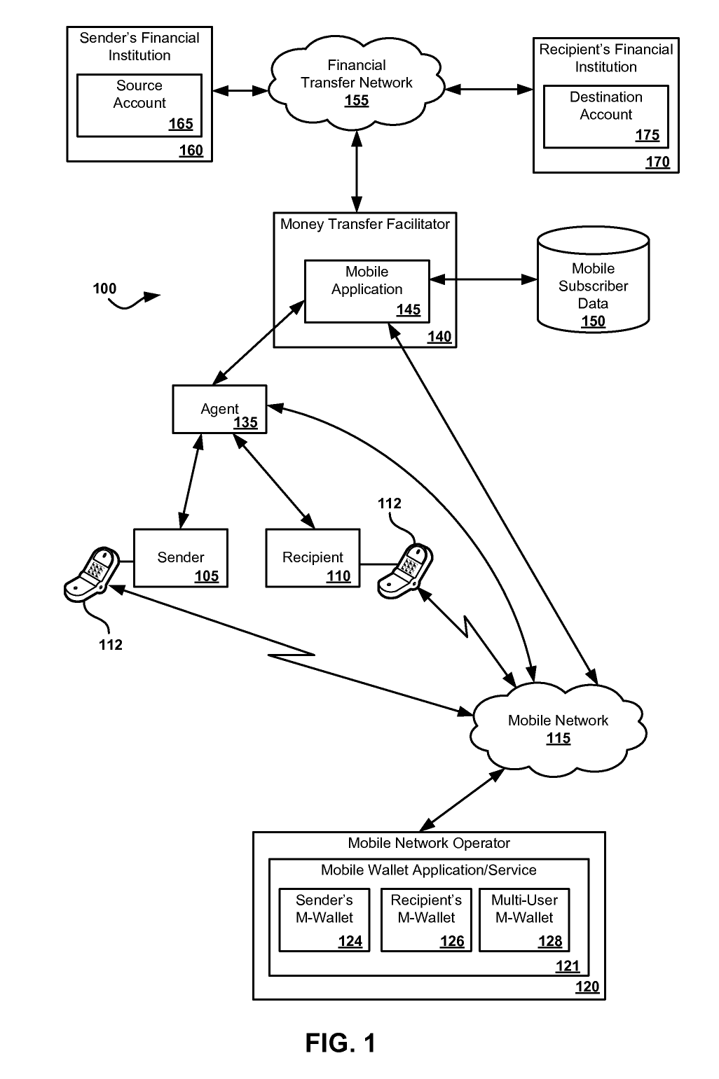

To better understand the invention through the description of a specific implementation, reference is made to FIG. 1, which is a block diagram illustrating an exemplary system 100 for conducting secure financial transfers according to one embodiment of the present invention. As illustrated, the system 100 can include a money transfer facilitator 140 system such as the systems operated by Western Union or another money transfer facilitator service. The money transfer facilitator 140 can be communicatively coupled with a financial transfer network 155. Also communicatively coupled with the financial transfer network 155 can be one or more financial institutions 160 and 170. Generally speaking and as understood by one skilled in the art, in some transactions the money transfer facilitator 140 may access a source account 165 of one financial institution 160 and/or a destination account 175 of the same or a different financial institution 170 to affect a transfer from and/or to the accounts 165 and 175 via the financial transfer network 155.

The money transfer facilitator system 140 can also include and execute a mobile application 145. As will be seen, the mobile application 145 of the money transfer facilitator can be adapted to support transactions involving one or more mobile devices. Generally speaking, the mobile application 145 can be adapted to identify the entities and/or accounts associated with a transaction and/or determine a destination for a payment of the transaction. For example, the entities and/or accounts can be identified based on a set of mobile subscriber data 150 maintained in a database or other repository. It should be noted that, while illustrated here as separate from the money transfer facilitator system 140, the mobile subscriber data 150 need not be separated from the money transfer facilitator system 140. Rather, the mobile subscriber data 150 can be either internal to or external from the money transfer facilitator system 140 depending upon the desired implementation.

The system can also include an agent 135 in communication with the money transfer facilitator 140. The agent 135 can comprise a retail outlet location and associated systems of the money transfer facilitator 140. Generally speaking, the agent 135 provides a channel by which entities can access the services of the money transfer facilitator 140. It should also be noted that, while not illustrated here for the sake of simplicity and clarity, the agent 135 and/or money transfer facilitator 140 can also provide other channels for accessing the services of the money transfer facilitator 140. For example, such channels can include but are not limited to a web site, a telephone service, a kiosk, an ATM or other channels. Generally speaking and as understood by one skilled in the art, via one or more such channels, a sender 105 can initiate a transaction to transfer money to a receiver or recipient 110. For example, a sender 105 can access the services of the money transfer facilitator 140 via a web site of the money transfer facilitator 140 and initiate a money transfer from a source account 165 owned by the sender 105. The recipient 110 of the payment may then, for example, pick up the payment from the agent's 135 retail location. In some embodiments, either the sender 105 or recipient 110 or both may conduct money transfers with the use of a mobile device 112. If both the sender 105 and recipient 110 use a mobile device 112, then money transfers may be directed between an account of the sender (e.g., account 165) to an account of the recipient (e.g., account 175), without the agent 135 being involved (e.g., as a payment pick-up location). The mobile devices 112 may be any one or more of various kinds of devices for communicating with network 115, such as a cellular phone, a personal communication device, or a notebook, notepad or laptop computer.

The system 100 can also include a mobile network 115, such as a cellular or other wireless network, communicatively coupled with the agent 135 and/or the money transfer facilitator 140. A mobile network operator system 120 can be communicatively coupled with the mobile network 115. As understood by one skilled in the art, the mobile network 115 and mobile network operator system 120 can support communications to and/or from mobile devices communicatively coupled therewith, such as the mobile devices 112 associated with the sender 105 and/or the recipient 110. It should be noted that the names sender and recipient are used only to illustrate a particular entity's and/or device's function at a given time and are not intended to imply any limitations on the functions that can be performed by a given entity and/or device. That is, any given entity and/or device associated with that entity can alternately act as sender or recipient. Also, it should be understood that while only one mobile network 115 and mobile network operator 120 are illustrated here for the sake of simplicity and clarity, multiple mobile networks 115 and mobile network operators 120 may be present. In some cases, the mobile network and mobile network operator of the sender 105 may be different from the mobile network and mobile network operator of the recipient 110.

The mobile network operator system 120 can include and/or execute a mobile wallet application 120 or service at the system/host computer of the mobile network operator 120. Generally speaking, the mobile wallet application 121 maintains mobile wallets 124 and 126 for one or more subscribers. The mobile wallets 124 and 126 can each comprise information related to the device and accounts of a user for whom the mobile wallet is maintained. For example, the sender's mobile wallet 124 can maintain information identifying the sender's 105 mobile device, one or more accounts 165 associated with the mobile wallet, and other identifying information (such as fingerprint data of sender 105, to be described later). Similarly, the recipient's mobile wallet 126 can maintain information identifying the recipient's 110 mobile device, one or more accounts 175 associated with the mobile wallet, and other identifying information (such as fingerprint data of recipient 110, to be described later).

Also shown in FIG. 1 is a multi-user mobile wallet 128, which is maintained for the benefit of a plurality users, e.g., for both sender 105 and recipient 110. Wallet 128 might be used to facilitate frequent transfers between a specific sender 105 and specific recipient 110, and thus wallet 128 maintains information identifying the mobile devices of both sender 105 and recipient 110, one or more accounts (such as accounts 165 and 175) associated with the users, and other identifying information (such as fingerprint data of both sender 105 and recipient 110). As should be appreciated, in some cases the sender 105 or recipient 110 may in fact each represent multiple users, for example, when one user (as a sender) wants to send money to multiple other users (as recipients), and thus the mobile device, account and fingerprint data for each of the multiple users (senders/recipients) would be maintained at the wallet 128.

According to one embodiment, the money transfer facilitator 140 can receive a request to initiate the money transfer transaction, for example a money transfer from the sender 105 to the recipient 110. The money transfer facilitator 140 can receive the request to initiate the money transfer transaction from the mobile wallet application 121 of mobile network operator 120, from a web site of the money transfer facilitator 140, from the agent 135, from a telephone money transfer service of the money transfer facilitator 140, from a kiosk, from an ATM or from another channel. The request can include a identifier/user ID for the sender 105 and for the recipient 110 as parties to the money transfer transaction. As examples, the user ID can comprise one or any combination of a phone number for a mobile device, an email address, an instant messaging identifier, a customer or account number, social security number, driver's license number, etc. In some cases the user ID may be chosen by the particular user based on his or her personal name. In addition, the request may also include a password or security code. In some cases, the user ID and password may have been earlier chosen by the user or, alternatively, issued within the system to the user (e.g., by the user's financial institution, by the facilitator 140 or by mobile network operator 120).

The source and destination for transferring funds for the money transfer transaction can be determined by the money transfer facilitator 140, agent 135, and/or mobile network operator 120 based at least in part on the unique identifier for the sender and recipient 110. It is assumed for the purposes of one described embodiment that at least the sender 105 is enrolled with the mobile wallet service 121 of the mobile network operator 120, and thus the mobile wallet 124 of the sender has the required information for identifying the sender, as well as information on accounts of the sender and fingerprint data for the sender's mobile device 112.

As will be described in greater detail later, device fingerprint data for each user enrolled with the mobile wallet application/service 121 has been earlier collected and stored at the application/service 121. Thus, the request to transfer money made at a mobile device 112 of the sender 105 includes the current fingerprint data from the mobile device, and that the fingerprint data (as well as user ID and, if required, password) are transmitted to the mobile network operator 120, where prior to passing the request on to the money transfer facilitator, the fingerprint data from the mobile device of the sender 105 is compared to reference fingerprint data stored at the mobile wallet application 121. If the fingerprint is judged to be sufficiently matched and authenticated based on a comparison of the fingerprint data in the request to the fingerprint data stored at the mobile wallet application/service 121, then the request is passed on to the money transfer facilitator 140 to complete the transaction.

If the sender is enrolled with the mobile wallet service 121 of the mobile network operator 120, but the recipient is not, the destination for transferring funds for the money transfer transaction to the recipient 110 can comprise a retail outlet of the money transfer facilitator or other designated destination, e.g., the agent's 135 location. Additionally or alternatively, in response to determining that the recipient 110 is not enrolled in the mobile wallet service 121 of the mobile network operator 120, a message can be sent to the recipient 110 inviting the recipient 110 to enroll in the mobile wallet service 121. If the recipient 110 enrolls in the mobile wallet service 121 of the mobile network operator 120, the destination for transferring funds for the money transfer transaction to the recipient 110 can comprise an account 175 associated with the mobile wallet 126 of the recipient 110. If the mobile network operator 120 for the recipient 110 does not have a relationship with the money transfer facilitator 140, the destination for transferring funds for the money transfer transaction to the recipient 110 can comprise a retail outlet of the money transfer facilitator or other designated destination, e.g., the agent's 135 location.

Once the destination for transferring funds for the money transfer transaction to the recipient 110 has been determined, the funds can be transferred to the determined destination and the recipient 110 can be notified of availability of funds at the determined destination. Notification can be sent by money transfer facilitator 140 to the recipient 110 and/or to any party associated with the designated destination (e.g., to a mobile network operator 120, a retailer, a bank, a service provider—payment service provider, auction service provider or Internet service provider—or any other party).

Where both the sender 105 and the recipient 110 have been enrolled prior to the money transfer request, the recipient 110 may not have any need to indentify himself/herself or contact the money transfer facilitator 140 or the mobile wallet service 121, unless the money has to be held for pick-up at an agent 135 location. In other words, the recipient wallet 126 sufficiently identifies any destination account 175 when the recipient has enrolled with the mobile wallet service 121. However, in some cases, the sender and recipient may together set up the multi-user wallet 128 as part of their enrollment. The wallet 128 is unlike wallet 124 and 126 in that it may be tailored specifically for transfers between two or more parties, and for the accounts from which and into which funds are to be placed as part of such transfers. The wallet 128 further includes fingerprint data for both parties (collected during enrollment). In one embodiment, use of the wallet 128 by either party (as a sender) requesting a money transfer to the other party (as a recipient) may require that the money transfer request from the sender be made to and accepted by the other party, in which case both fingerprints will be authenticated, i.e., the sender fingerprint is authenticated by the mobile wallet service 121 when it receives the request from the sender's mobile device 112, and the fingerprint of the recipient is authenticated by the mobile wallet service 121 when the recipient transmits an acceptance of the money transfer from that recipient's mobile device 112 to the mobile wallet service 121.

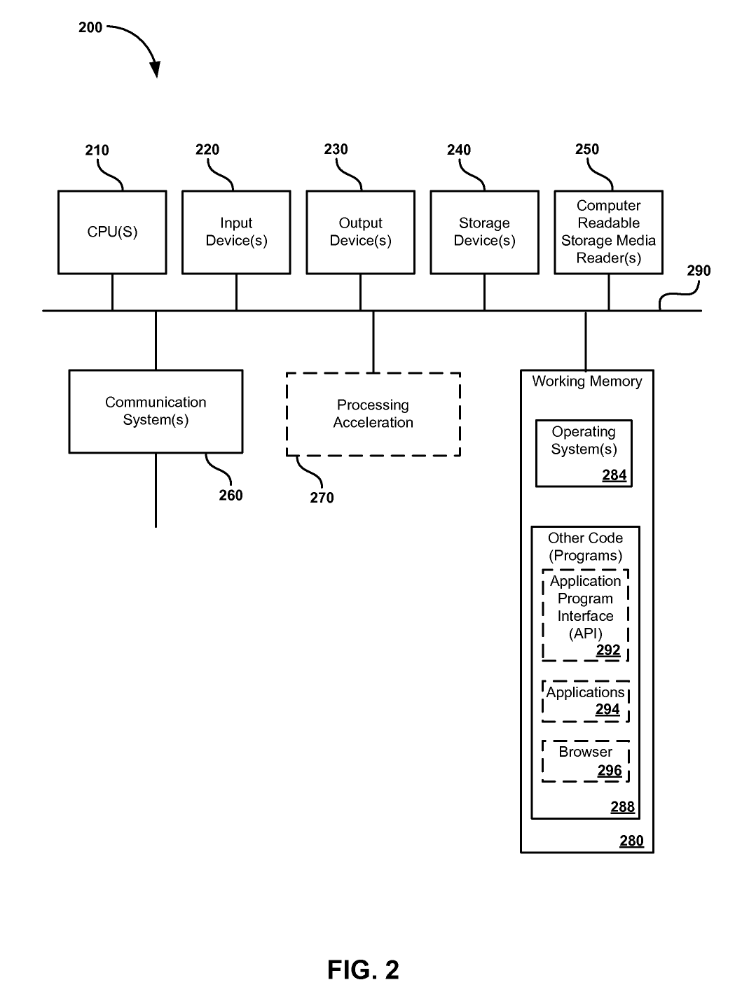

FIG. 2 is a block diagram illustrating an exemplary computer system upon which embodiments of the present invention may be implemented. This example illustrates a computer system 200 such as may be used, in whole, in part, or with various modifications, to provide the functions of the sender's mobile device, the receiver's mobile device, the agent 135 system, the money transfer facilitator system 140, the mobile network operator system 120, and/or other components of the invention such as those discussed above.

The computer system 200 is shown comprising hardware elements that may be electrically coupled via a bus 290. The hardware elements may include one or more central processing units 210, one or more input devices 220 (e.g., a mouse, a keyboard, etc.), and one or more output devices 230 (e.g., a display device, a printer, etc.). The computer system 200 may also include one or more storage devices 240, representing remote, local, fixed, and/or removable storage devices and storage media for temporarily and/or more permanently containing computer-readable information, and one or more storage media reader(s) 250 for accessing the storage device(s) 240. By way of example, storage device(s) 240 may be disk drives, optical storage devices, solid-state storage device such as a random access memory (“RAM”) and/or a read-only memory (“ROM”), which can be programmable, flash-updateable or the like.

The computer system 200 may additionally include a communications system 260 (e.g., a modem, a network card—wireless or wired, an infra-red communication device, a Bluetooth™ device, a near field communications (NFC) device, a cellular communication device, etc.) The communications system 260 may permit data to be exchanged with a network, system, computer, mobile device and/or other component as described earlier. The system 200 also includes working memory 280, which may include RAM and ROM devices as described above. In some embodiments, the computer system 200 may also include a processing acceleration unit 270, which can include a digital signal processor, a special-purpose processor and/or the like.

The computer system 200 may also comprise software elements, shown as being located within a working memory 280, including an operating system 284 and/or other code 288. Software code 288 may be used for implementing functions of various elements of the architecture as described herein. For example, software, stored on and/or executed by a computer system, such as system 200, can provide the functions at the user devices of the sender 105 and recipient 110, at mobile network operator 120 (including the mobile wallet application/service 121), at the agent 135 system, and at the money transfer facilitator 140 system.

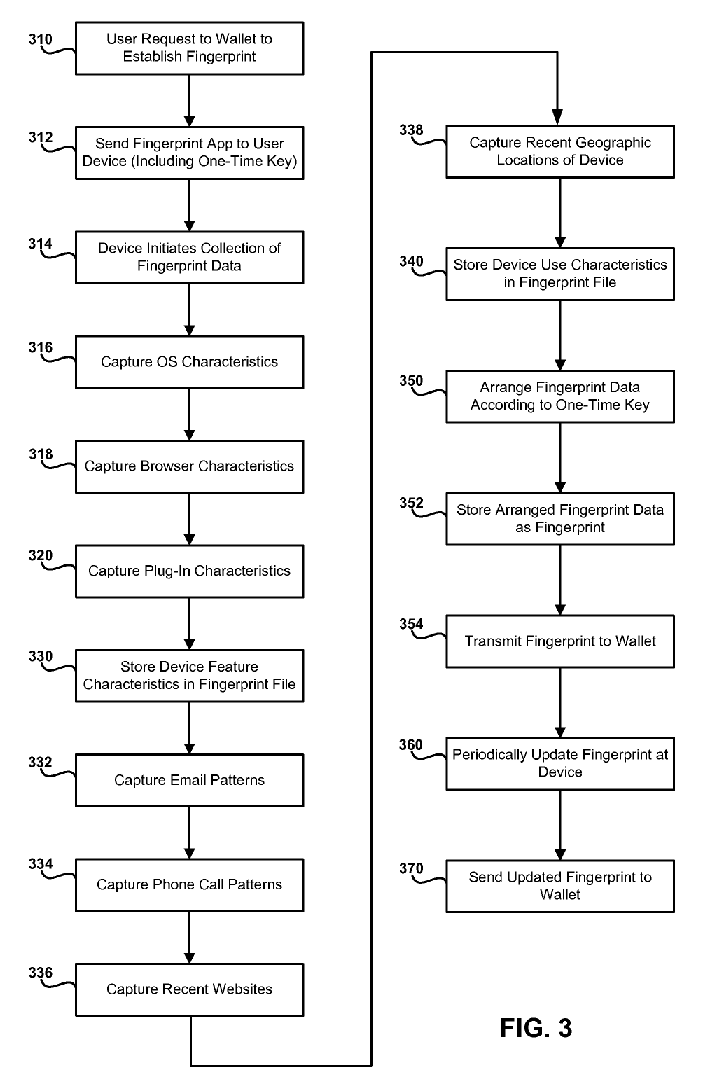

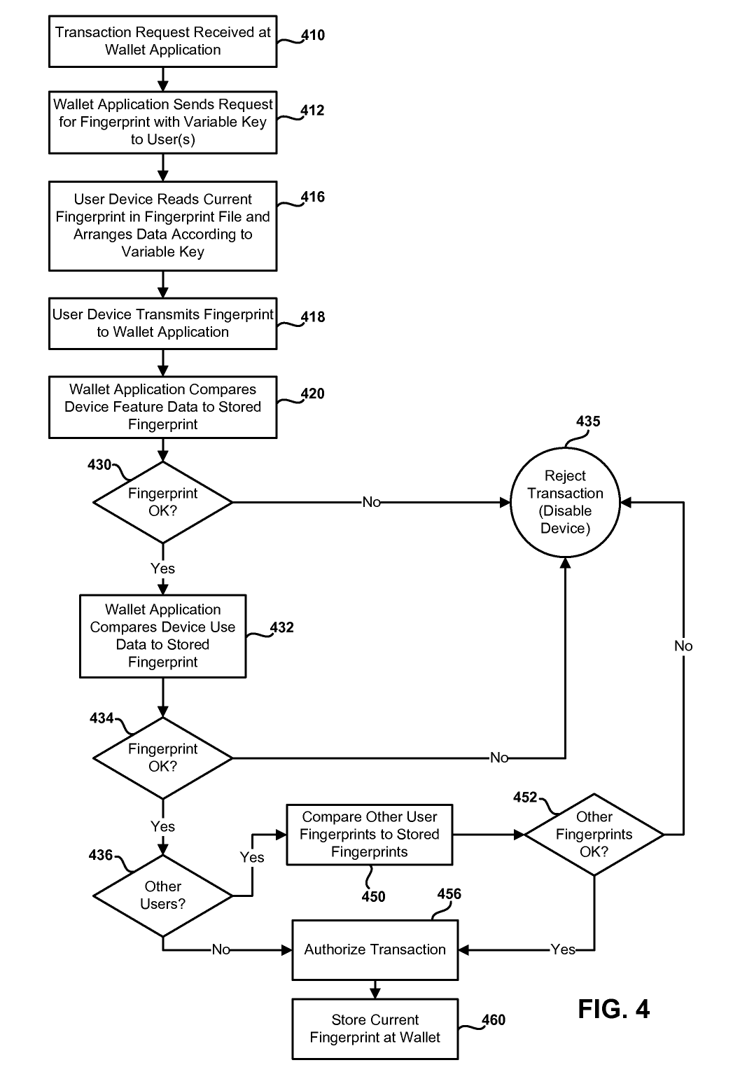

Also seen in FIG. 2 are specific examples of common software components (application program interface (API) 292, applications 294, and a browser 296) that may resident in the code 288 in several of the systems seen in FIG. 1. The context and use of such common software components in connection with one embodiment of the invention will be described in greater detail below in conjunction with FIGS. 3 and 4.

It should be appreciated that alternate embodiments of a computer system 200 may have numerous variations from that described above. For example, customized hardware might also be used and/or particular elements might be implemented in hardware, software (including portable software, such as applets), or both. Furthermore, there may connection to other computing devices such as network input/output and data acquisition devices (not shown).

FIG. 3 illustrates an exemplary flow or process for establishing a device fingerprint for the mobile device 112 of a user (such as sender 105 or recipient 110). At step 310, the user requests to enroll with the mobile wallet application/service 121 (and will establish a fingerprint as part of that enrollment). While not illustrated in FIG. 3, enrollment also involves collection of various kinds of information (other than fingerprint data) from the user, such as user ID, device identifier, password, account information and so forth, all of which are known and thus the details pertaining to such collection of that other information is not discussed further. The enrollment request may be initiated by the user in response to various circumstances, such as the user being invited to enroll via email (received at the mobile device 112), the user visiting the agent 135 and being invited to enroll for future transactions, or as part of the user's initial subscription to wireless service over mobile network 115. The request to enroll may be sent in the form of an email or other transmission to the mobile service operator from the mobile device 112. It may also be made in person at the location of agent 135, made on-line using a website operated by either the mobile network operator 120 or money transfer facilitator 140, or made in some other similar fashion.

In response to the user's request to enroll, a fingerprint application (such as an applet) is sent at step 312 from the mobile wallet application 121 to the mobile device 112. That application may be sent to the mobile device 112 over mobile network 115. Alternatively, if enrollment takes place at an agent 135 location, the application can be downloaded to the mobile device, for example, through a wired connection (a cable connected between the mobile device 112 and the agent/facilitator system), or if the mobile device 112 has a near field communications capability (or other direct wireless communications capability), wirelessly from the agent/facilitator system. The mobile device 112 executes the fingerprint application to initiate the collection or capture of device fingerprint data at the mobile device, step 314.

In the embodiment illustrated in FIG. 3, two types of fingerprint data are collected at mobile device 112, namely, (1) device feature characteristics or data (such data is related to “machine” characteristics, rather than the operation of the mobile device by its end user, and is collected at steps 316, 318 and 320), and (2) device use characteristics or data (such data is related to the manner in which the mobile device is used or operated by its end user, and is collected at steps 332, 334, 336 and 338).

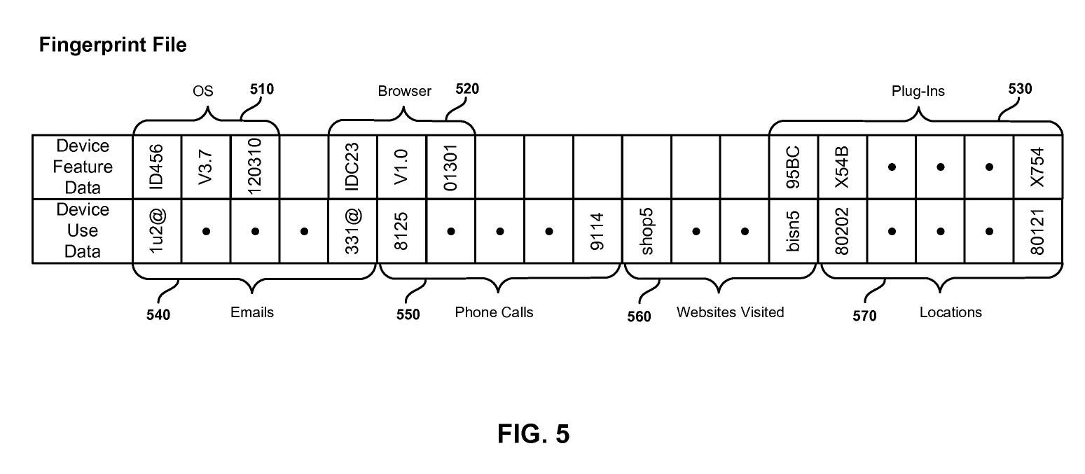

In order to capture device feature characteristics, the mobile device first executes, at step 316, a call to the operating system 284 within mobile device 112 to retrieve operating system features, such as operating system (OS) name or ID, OS version number and OS install date (such features are typically stored as system properties in the operating system of the mobile device 112 and are updated as the operating system itself is installed or updated). At step 318, a call is made to the operating system within mobile device 112 or directly to the browser 296 to obtain similar information from the browser (browser name or ID, version number and install date). In some cases, more than one browser may be installed and, if desired, information on each browser may be collected. Finally, at step 320 a call is made to the application program interface 292 (which stores identification information on installed plug-ins), where similar information is collected for each application or plug-in installed on the mobile device (plug-in name or ID, version number and install date). As an example, for mobile devices using Java-based operating systems, a Java API resident in system memory typically contains a registry with information on each installed plug-in. While mobile devices used primarily as communications devices may have a limited number of plug-ins (e.g., ten or less), in cases where a larger number have been installed, the fingerprint application could capture data only on the most recently installed plug-ins (say, the most recent ten), since such amount of data would suffice in many cases for purposes of identifying one device over another. After the data is collected at steps 316, 318 and 320, it is stored in a fingerprint file within the memory of the mobile device (step 330). The fingerprint file will be described in more detail later in conjunction with FIG. 5.

After capturing device feature characteristics, the fingerprint application at the mobile device captures device use characteristics including, at step 332, retrieving data from a record or log of recent emails within an email program used at the mobile device. While different types of email logs maybe stored within the email program on mobile device 112 (e.g., sent, received, and deleted), as one example, the emails retrieved would be the 50 most recent sent emails, identified by recipient email address. As another example, the fingerprint application could look at a longer list of emails sent (say, the 100 most recent emails), but then sort and capture the ten most frequent recipients in those emails. Other possible categories and numbers of email are, of course, possible.

At step 334, a similar process is used for capturing data for phone calls sent/received at the mobile device (e.g., fifty most recent phone calls sent from the mobile device 112). Then, at step 336, recent websites visited are retrieved from the browser and, at step 338, recent geographical locations (e.g., postal or other location codes) where the mobile device has been located/used are retrieved. As to recent locations, such data could be taken from a record of locations taken periodically over a specified period of time (say one week) based on a GPS application running on mobile device 112. Alternatively, the data could be based on a record of cellular service towers providing wireless service to the mobile device 112, which might be maintained at mobile network 115 and, upon request, downloaded to mobile device 112. Finally, the data captured at steps 332, 334, 336 and 338 is stored in the fingerprint file at the mobile device, step 340.

It should be appreciated that the categories or types of device feature data and device use data illustrated as captured at steps 316-320 and 332-338 are exemplary, and many other types of data representing device features, uses or operations could additionally, or alternatively, be captured to provide a device fingerprint that is unique to each mobile device 112. As should be apparent, the likelihood that the fingerprint will be unique will increase as more data (and types of data) is captured. As examples only, additional device feature characteristics could include hardware features, other software features, or data from the mobile device SIM (Subscriber Identity Module) card.

The various components of the captured data is then arranged, at step 350, within the fingerprint file according to a one-time key previously provided with the fingerprint application at step 312. In one embodiment, the one-time key may be merely an indication of the order in which the various captured fingerprint data components are arranged in the fingerprint file. In other embodiments, the one-time key may be a public key for a more sophisticated encryption algorithm. One purpose for at least rearranging the fingerprint data components (according to the one-time key) would be to make it more difficult for a person who has possession of the mobile device (such as a thief) to determine the make-up of the fingerprint and use that information to fraudulently create fingerprints that could be used later to conduct fraudulent transactions.

The properly arranged fingerprint data is stored in the fingerprint file and then also transmitted (step 354) to the appropriate wallet 124, 126, 128 at the mobile wallet application 121, along with other enrollment data (user name, ID, password, account number(s), etc.) pertaining to the mobile device 112 and its user. The fingerprint sent to the wallet at step 354 will later be used as a reference fingerprint for comparison in order to authenticate the user and his/her mobile device 112.

The mobile device 112 may also periodically update (e.g., under direction of the fingerprint application) the fingerprint at step 360, essentially repeating the process (e.g., steps 314-352), so that as device feature and use characteristics change, the fingerprint stored at mobile device 112 is kept reasonably current.

In addition, the updated fingerprint data may be periodically sent to the wallet (step 370) to update the reference fingerprint, although the frequency of such step (or whether it is even done at all) may depend on the design of the system and desire of the operator as to the degree of variance in fingerprints the mobile wallet application service 121 will accept in order to authenticate the mobile device 112 (e.g., if a very close match of a fingerprint is expected in order to authenticate, the updated fingerprint will likely need to be sent frequently to the mobile wallet application 121 for storage in the appropriate wallet).

Turning now to FIG. 4, there is illustrated an exemplary flow or process for authenticating a fingerprint as part of processing a transaction request made by a user at the mobile device 112, as implemented by programs executed at the mobile device 112 and the mobile wallet application 121. At step 410, a request (such as for a money transfer transaction) is received at mobile wallet application 121 at one of the wallets 124-128 (the wallet involved will depend, among other things, on the ID of the sender and/or recipient), and in response the mobile wallet application 121 returns a request for the fingerprint to the mobile device, step 412. The request from the application 121 to the mobile device 112 may include an encryption key, which is variable (i.e., it may vary or change for each request), that is used to rearrange the fingerprint stored in the fingerprint file of the mobile device (step 416) prior to be sent to application 121 at the mobile network operator. As with the one-time key used to initially store the fingerprint at the mobile device 112 (steps 350, 352), the variable key may be merely an indication of the order in which the various fingerprint data is to be arranged for transmission to the mobile wallet application. Alternatively, the variable key may be a public key for a more sophisticated encryption algorithm, for encrypting the fingerprint data prior to transmission. In either case, one purpose of rearranging or encrypting the fingerprint data components (according to the variable key) would be to make it more difficult for a person (who may improperly intercept the return of the fingerprint to the mobile application 121) to later use the fingerprint to conduct fraudulent transactions using that fingerprint.

Further, it should be appreciated that in some cases the request for a fingerprint (and the accompanying variable key) at step 412 may be sent to multiple users and their mobile devices 112. For example, if the transaction involves the multi-user wallet 128, then the request is sent to each user involved in the transaction as either a sender and a recipient.

The encrypted fingerprint from the mobile device 112 is returned to the wallet application 121 at step 418, where it is compared to the reference fingerprint for the same device that is stored at the appropriate wallet. As seen in FIG. 4, the fingerprint comparison may be done in two stages, with a comparison first made at step 420 of device feature data or characteristics (e.g., operating system, browser and plug-in characteristics), and then a comparison of device use data or characteristics (e.g., email patterns, phone call patterns, visited websites and location patterns). The advantage of separating the comparisons of device features and device uses is that a lack of a good match for device features may indicate a significant change to the device, such as may result from the device being stolen. For example, in some cases, a thief may change an operating system, swap out email programs and make similar basic changes to the device in order to use the device for fraudulent transactions. Evidence of such changes may give rise to a higher level of concern about the device having been stolen. On the other hand, device use changes may be indicative of normal changing patterns of use by the same user. For example, if a user has changed jobs or had some other change in personal circumstances, the pattern of uses of the user's mobile device may correspondingly change. The mobile network operator 120 may thus desire to distinguish between changes in device features and changes in device uses, particularly if the operator is aware of changes in personal circumstances. In some embodiments, a network operator may permit fewer variances (or no variances at all) in device features when deciding if there is a match of fingerprint device features characteristics (step 430). However, the network operator may permit more variances in device use characteristics when deciding if there is a match of fingerprint device use characteristics (step 434). In either case, if the match fails, the device is disabled for purposes of the transaction (step 435). Other steps could be taken, such as an email to the user at the last authorized email address, an alert to authorities of the possible fraudulent activity, and other mitigating actions (an audit of recent transactions, notifying the user's financial institution for possible follow-up, etc.).

In other embodiments, the comparison of fingerprint data may be done as a single step without separately comparing device feature characteristics and device use characteristics.

It should be noted that while, in some cases, the comparison of fingerprint data at the mobile wallet application 121 is more quantitative (e.g., variances of more than a certain amount, such as 10%, in one or more categories of device uses could indicate that the compared fingerprints are not the same), in other cases the comparison may be more qualitative or a combination of quantitative and qualitative. Also, some characteristics may be given more weight than others, and the comparisons may relate to patterns of fingerprint components rather than individual components. As one example, the area codes of phone calls can be compared, and if the fingerprint sent from the mobile device shows a pattern of calls to suspicious area codes never before seen in a fingerprint at the wallet, fewer variances from past activity may be acceptable. As another example, if the locations (captured at step 338) sent as part of a fingerprint from the mobile device evidence a stable past pattern with a sudden, dramatic change from the pattern (e.g., prior uses confined to certain states in the US, and then the updated fingerprint from the mobile device reflecting use of the device in a foreign country), such a variance in itself may be sufficient reason to disable the device. Many other methodologies and algorithms for comparing individual fingerprint components or patterns of components could be used is addition to or as alternatives to those described herein, depending on the design of the system and the degree of certainty (risk avoidance) desired by the operator of the system.

Once a fingerprint is authenticated for a mobile device, the wallet application 121 determines (step 436) if there are multiple users to be authenticated, such as when the transaction is conducted using the multi-party wallet 128. While not shown, the wallet application may request fingerprints from the devices of the other users. If the other fingerprints are authenticated (steps 450, 452), the transaction is authorized (step 456). If the other fingerprints are not matched at step 452, the transaction is disabled. Alternatively, if a sender fingerprint is authenticated (matched), and one or more of the recipient fingerprints is not authenticated, the amount in the money transfer transaction can be held, until resolved, e.g., in an account maintained at the mobile wallet application 121 or at the money transfer facilitator 140. As mentioned earlier, the authentication of multiple fingerprints (fingerprints for both the sender 105 and one or more recipients 110), increases the opportunity to detect a fraudulent transaction (since multiple mobile devices are providing fingerprints that all need to be authenticated in order to complete the transaction).

Finally, at step 460, if the fingerprint sent by the mobile device 112 is authenticated, it may be stored at the wallet corresponding to the user (as an updated reference fingerprint), and used in subsequent transactions for authentication.

FIG. 5 illustrates an example of a fingerprint file (and the components of the fingerprint data) captured and stored at a mobile device using the exemplary process illustrated in FIG. 3.

As illustrated, the fingerprint file stores device feature data or characteristics, such as an operating system (OS) data 510 (OS ID, OS version/release number, and OS install/release date), and browser data 520 (browser ID, browser version/release number, and browser install/release date). The fingerprint file also includes IDs 530 for each of the plug-ins installed on the mobile device 112. Although not illustrated, mobile devices often store install dates for each installed plug-in (time-stamped at the time of installation) and that data could also be captured and stored in the fingerprint file.

The fingerprint file also stores device use data or characteristics, such as email data 540 (e.g., identifying portions of email addresses), phone calls 550 (e.g., some or all digits of numbers called), visited websites 560 (e.g., website IP address), and locations 570 where the mobile device has been located or used over a given period of time (e.g., postal codes, location IDs, etc.).

While fingerprint file data illustrated in FIG. 5 is the data stored in memory at the mobile device 112, such data may also represent the fingerprint sent as a reference fingerprint to the wallet application 121 and also stored in the appropriate wallet 124-128 at the wallet application 121. The illustrated data is exemplary only, and as mentioned earlier, an actual fingerprint may have less data, more data or different data that that shown. Also, such data in the fingerprint file may be re-arranged or scrambled (based on the one-time key mentioned in conjunction with step 312) in an order other than that shown.

While the invention has been described with respect to exemplary embodiments, one skilled in the art will recognize that numerous modifications are possible. As examples only, while each of the wallets 124, 126 and 128 are described as keeping only a single fingerprint for each device (e.g., the most recent fingerprint sent from the mobile device 112), the wallets may alternatively store multiple fingerprints representing a historical record or log of fingerprints, with comparisons made against all such historical fingerprints (and the trend or pattern of such fingerprints), which may result in more accurate authentication. Further, while the mobile device 112 is described as storing the device fingerprint (either initially or as updated, steps 352 and 360), the mobile device may alternatively capture a fingerprint “on the fly,” e.g., at the time each transaction is requested from the mobile device. Also, while the storing of reference fingerprints of wallets 124-128 and the comparison of current and reference fingerprints are both illustrated as being done at the mobile network operator 120 system, such functions could be located elsewhere, e.g., combined with other money transfer transactions performed at the money transfer facilitator 140 system.

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention.

Moreover, while the various flows and processes described herein (e.g., those illustrated in FIGS. 3 and 4) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for providing security to a financial transaction conducted at a user device, comprising:
initially collecting fingerprint data from the user device, the fingerprint data including both data relating to features of the user device and data relating to use of the user device;
transmitting the initially collected fingerprint data to a host computer, and storing the initially collected fingerprint data at the host computer as a reference fingerprint;
when a financial transaction is to be conducted at the user device, transmitting current fingerprint data collected at the user device to the host computer, the current fingerprint data corresponding to the fingerprint data initially collected at the user device;
comparing the current fingerprint data to the reference fingerprint at the host; and
based on the comparison, determining at the host computer whether to authorize the financial transaction.

2. The method of claim 1,
wherein the data relating to features of the user device comprises one or more of:
characteristics relating to the operating system of the user device;
characteristics relating to applications installed at the user device;
characteristics relating to a browser installed at the user device; and
wherein the data relating to use of the user device comprises one or more of:
characteristics relating to email sent or received at the user device;
characteristics relating to telephone calls made or received at the user device;
characteristics' relating to websites visited by the user device; and
characteristics relating to a location of the user device.

3. The method of claim 1, wherein the user device is a mobile device.

4. The method of claim 1, wherein the host computer includes a mobile wallet application, wherein the reference fingerprint is stored in at least one of a plurality of wallets maintained at the wallet application, wherein multiple users conduct financial transactions using the wallet application, and wherein each user is associated with at least one of the wallets maintained at the wallet application.

5. The method of claim 1, wherein at least one of the plurality of wallet is a multi-user wallet, for storing a reference fingerprint for each of a plurality of users.

6. The method of claim 1, further comprising:
storing the initially collected fingerprint data at the user device.

7. The method of claim 6, further comprising periodically updating the initially collected fingerprint data, wherein the step of storing the initially collected fingerprint data at the user device includes storing the updated fingerprint data at the user device, and wherein the step of transmitting current fingerprint data collected at the user device comprises transmitting the updated fingerprint data stored at the user device.

8. The method of claim 1, wherein the step of transmitting current fingerprint data collected at the user device to the host computer comprises:
collecting fingerprint data at the user device at the time the financial transaction is conducted; and
transmitting the fingerprint data collected a the time of the financial transaction is conducted to the host computer.

9. The method of claim 1, further comprising:
periodically updating the initially collected fingerprint data;
transmitting the updated fingerprint data to the host computer; and
in response to receiving the updated fingerprint data at the host computer, storing the updated fingerprint data at the host computer as the reference fingerprint.

10. The method of claim 9, wherein a plurality of reference fingerprints are stored at the host computer, each representing updated fingerprint data collected at a different point in time, and wherein the step of determining at the host computer whether to authorize the financial transaction includes using the plurality of reference fingerprints in the comparison.

11. The method of claim 9, further comprising:
providing a fingerprint application to the user device, and wherein the fingerprint application, when executed at the user device, performs the steps of initially collecting fingerprint data from the user device and periodically updating the initially collected fingerprint data.

12. The method of claim 11, wherein the fingerprint application is provided to the user device over a wireless communications network.

13. The method of claim 11, wherein the financial transaction is a consumer-oriented money transfer transaction, and wherein the fingerprint application is provided to the user device at a money transfer agent location.

14. A method for authorizing a financial transaction conducted at a user mobile device, comprising:
collecting fingerprint data at the user device, the fingerprint data comprising multiple characteristics related to the user device, wherein at least some of the characteristics vary over time;
transmitting the fingerprint data to a host computer;
storing the provided fingerprint data at the host computer as a reference fingerprint;
periodically updating the reference fingerprint by collecting updated fingerprint data at the user device, providing the updated fingerprint data to the host computer, and storing the updated fingerprint data at the host computer as the reference fingerprint;
when a financial transaction is to be conducted at the user device, transmitting current fingerprint data at the user device to the host computer;
comparing the transmitted current device fingerprint data to the reference fingerprint stored at the host; and
based on the comparison, determining whether to authorize the financial transaction.

15. A system for providing secure transactions, comprising:
a user device configured to:
collect fingerprint data for the user device, the fingerprint data including both device feature data and device use data, the device feature data comprising data identifying components installed on the user device, the device use data comprising data identifying uses of the device by a user of the user device;
transmit a first, collected fingerprint data to a host computer; and
when a transaction is to be conducted at the user device, transmit a second, current fingerprint data collected at the user device; and
a host computer communicatively coupled to the mobile device and configured to:
store the first fingerprint data as a reference fingerprint;
compare the second, current fingerprint data to the reference fingerprint at the host; and
based on the comparison, determine whether to authorize the transaction.

16. The system of claim 15,
wherein the data identifying components installed on the user device comprises one or more of:
characteristics relating to the operating system of the user device;
characteristics relating to applications installed at the user device;
characteristics relating to a browser installed at the user device; and
wherein the data identifying uses of the device comprises one or more of:
characteristics relating to email sent or received at the user device;
characteristics relating to telephone calls made or received at the user device;
characteristics' relating to websites visited by the user device; and
characteristics relating to a location of the user device.

17. The system of claim 15, wherein the user device is a mobile device.

18. The method of claim 17, wherein the host computer comprises a mobile wallet application, wherein the reference fingerprint is stored in at least one of a plurality of wallets maintained at the wallet application, wherein multiple users conduct transactions using the wallet application, and wherein each user is associated with at least one of the wallets maintained at the wallet application.

19. The system of claim 18, wherein at least one of the plurality of wallets is a multi-user wallet, for storing a reference fingerprint for each of a plurality of users.

20. The system of claim 17, wherein the user device is further configured to:
store the first, collected fingerprint data at the user device.

21. The system of claim 17,
wherein the user device is further configured to:
periodically update the first, collected fingerprint data; and
transmit the updated fingerprint data to the host computer; and
wherein the host computer is further configured to:
in response to receiving the updated fingerprint data at the host computer, storing the updated fingerprint data at the host computer as the reference fingerprint.

22. The method of claim 17, wherein a plurality of reference fingerprints are stored at the host computer, each representing updated fingerprint data collected at a different points in time, and wherein the host computer is further configured to:
compare the second, current fingerprint data to the plurality of reference fingerprints at the host; and
determine whether to authorize the transaction based on the comparison to the plurality of reference fingerprints.
